(19) United States
(12) Patent Application Publication
(10) Pub. No.: US 2005/0185408 A1
(43) Pub. Date: Aug. 25, 2005

(54) Lamp unit and display device of projector system

(75) Inventors: Yeon-sig Jin, Suwon-si (KR); Myung-ryul Jung, Suwon-si (KR); Sang-su Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/055,700

(22) Filed: Feb. 11, 2005

(30) Foreign Application Priority Data
Feb. 20, 2004 (KR) 2004-11452

(51) Int. Cl. F21V 13/10

(52) U.S. Cl. 362/303; 362/351

(57) ABSTRACT

A lamp unit of a projector system and a display device using the same, includes a lamp; a reflector for reflecting a light generated from the lamp; and a cover glass mounted at an opening of the reflector, and the cover glass having a blocking device for obstructing a light incident from an optical system, disposed in front of the light with respect to a light projecting direction, to the reflector. Accordingly, a light irradiated to the lamp, which increases the temperature of an electrode welding part of the lamp, can be blocked, thereby improving a lifespan of the lamp.

### CROSS-REFERENCE TO RELATED APPLICATION

This application claims the benefit of Korean Patent Application No. 2004-11452, filed Feb. 20, 2004, in the Korean Intellectual Property Office, the disclosure of which is incorporated herein by reference.

### BACKGROUND OF THE INVENTION

1. Field of the invention The present invention relates to a projector system. More particularly, an apparatus consistent with the present invention relates to a lamp unit for a digital light processing (DLP) or a liquid crystal display (LCD) projector system, and a display device using the same.

2. Description of the Related Art

Recently, a digital light processing (DLP) projector or a liquid crystal display (LCD) projector which employs a digital micromirror display (DMD) panel is widely used for a wide-screen image projecting system.

FIG. 1 is a schematic view of a conventional DMD projector system which comprises a lamp unit 10 and an optical system 80.

The lamp unit 10 has a lamp 20 mounted within a reflector 30 and a cover glass 40 disposed at an opening of the reflector 30 to prevent scatter of the lamp 20 in the event of breakage of the lamp 20.

The optical system 80 comprises an ultra-violet (UV) filter 50 for blocking ultraviolet rays generated from the lamp 20, a color wheel 60 for separating the light generated in the lamp 20 into red, green and blue, a light tunnel 70 for splitting an arc generated in the lamp 20 and rearranging the split arc pieces into a substantially even square form of light, a DMD panel 82 for reflecting the light passed through the color wheel 60 and the light tunnel 70, and a lens 92 for converting the light projected from the DMD panel 82 into a transmitted light and projecting the transmitted light to a screen 94.

The operation of the lamp unit 10 and a display device will be briefly described hereinbelow.

By applying voltage to an electrode 26 through a lead line 43, an external lead 27 and a metal film 28, electric discharge occurs, and this causes an increase of temperature within a discharge space 23 of a luminescent pipe 22. Accordingly, mercury in the discharge space 23 is heated, and a mercury atom is excited and radiates at an arc center between a pair of the electrodes 26.

The light generated in the lamp 20, colliding with the reflector 30, is projected toward the optical system 80 and split into three primary colors, while passing through the tilted UV filter 50 and the color wheel 60. A light 72 being split into pieces and formed as a substantial square in the light tunnel 70 is irradiated to the DMD panel 82, and a light 74 reflected by the DMD panel 82 becomes a transmitted light 76 passing through the lens 92 and therefore is projected to the screen 94.

Here, a part of the light from the lamp 20 is not passed through the UV filter 50 and the color wheel 60, but is reflected and returned to the lamp unit 10.

More specifically, ultraviolet rays of the light generated from the lamp 20 are blocked off by the UV filter 50 and incident toward the lamp unit 10 as reflection lights 62 and 63. A light passed through the UV filter 50 but blocked off by the color wheel 60 enters toward the lamp unit 10 as a reflection light 61.

The reflection lights 61, 62 and 63 are irradiated to a light emitting pipe 22 and an electrode welding part 29 of the lamp unit 10, thereby increasing the temperature of the light emitting pipe 22 and the electrode welding part 29.

However, the high temperature of the returning UV rays, among the reflected lights 61, 62 and 63 which are reflected by the UV filter 50, causes a problem of reducing a lifespan of the lamp 20 since the UV rays irradiate to the electrode welding part 29 and the light emitting pipe 22 of the lamp 20.

More specifically, since the metal film 28 and the lead line 27 are formed of molybdenum, if the temperature of the electrode welding part 29, which consists of the metal film 28 and the lead line 27, increases to an amount equal to or greater than approximately 350° C., the electrode welding part 29 is oxidized and becomes very susceptible to a high temperature.

The above-noted increase in temperature of the light emitting pipe 22 causes efflorescence, thereby shortening a lifespan of the lamp 20. The above-noted increase in temperature of the electrode welding part 29 causes oxidation and therefore loses conductivity. Accordingly, the lamp 20 cannot operate in a normal manner.

Such problematic light, among the lights incident to the reflector 30 of the lamp unit 10, is the light irradiated to the electrode welding part 29 and the light emitting pipe 22. In order to overcome the above shortcoming, a reflection film for reflecting the light irradiated to the electrode welding part 29 is provided near the electrode welding part 29.

However, it is a very troublesome and complicated process to form the reflection film near the electrode welding part 29 of the lamp 20 of the lamp unit 10. Consequently, the manufacturing cost of the lamp unit 10 increases.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

An aspect of the present invention is to solve at least the above problems and/or disadvantages and to provide at least the advantages described below. Accordingly, an aspect of the present invention is to provide a lamp unit having a means for blocking a light returning to the lamp unit, and a display device having the same.

Another aspect of the present invention is to provide a display device comprising a UV filter perpendicularly mounted to enhance retroreflection efficiency of a light incident again to a lamp unit.

In order to achieve the above-described aspects of the present invention, there is provided a lamp unit for a projector system, comprising a lamp; a reflector for reflecting a light generated from the lamp; and a cover glass mounted at an opening of the reflector, and the cover glass having means for blocking a light incident from an optical system, disposed in front of the light with respect to a light projecting direction, to the reflector.

The blocking means is substantially disposed at the center of the cover glass.

The blocking means may be integrally formed with or attached to the cover glass and may be attached to the cover glass by inorganic adhesive. Also, the blocking means may be formed by sanding the cover glass.

In order to achieve another aspect of the present invention, there is provided a display device for a projector system, comprising a lamp unit including a lamp, a reflector for reflecting a light generated from the lamp, a cover glass mounted at an opening of the reflector and a blocking means for obstructing a light incident to the reflector, and an optical system including a UV filter disposed in front of the lamp unit to block a UV ray among lights generated at a lamp, a color wheel for separating the light from the lamp into red, green and blue (RGB) and sequentially supplying the RGB colors to an optical engine, a light tunnel for splitting an arc generated from the lamp into pieces and rearranging the pieces into a light of a substantially even square, a digital micromirror device (DMD) panel and a lens. The UV filter is substantially vertically mounted.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a schematic view of a display device for a conventional projector system;

FIG. 2 is a side view of a lamp unit according to an exemplary embodiment of the present invention;

FIG. 3 is a front view of FIG. 2;

FIG. 4 is a schematic view or a projector system according to an exemplary embodiment of the present invention;

FIG. 5A illustrates a path of a light when a UV filter is vertically mounted, according to an exemplary embodiment of the present invention; and

FIG. 5B illustrates a path of a light when the UV filter of FIG. 5A is slanted by a predetermined angle.

### DETAILED DESCRIPTION OF THE EXEMPLARY EMBODIMENT

Hereinafter, an exemplary embodiment of the present invention will be described in detail with reference to the accompanying drawing figures.

In the following description, the same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

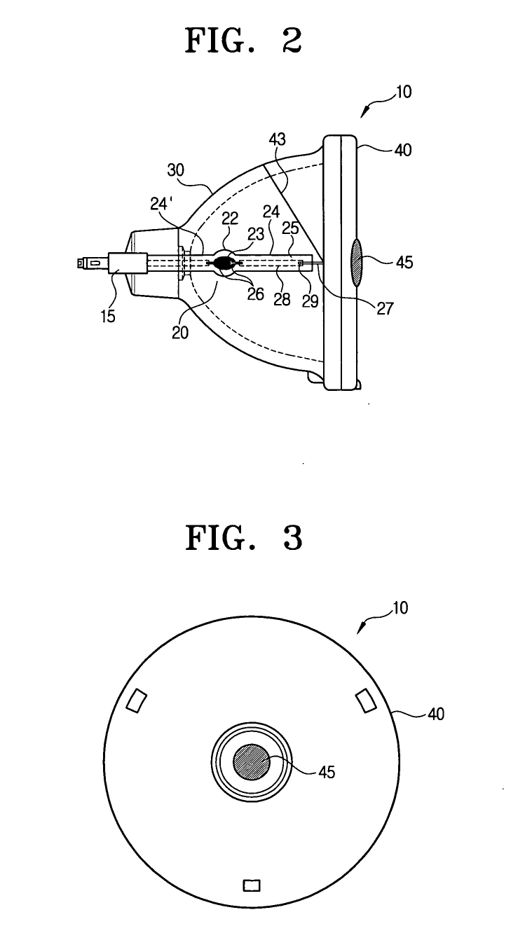

Referring to FIGS. 2 and 3, a lamp unit 10 comprises a lamp 20 mounted within a reflector 30, a cover glass 40 disposed at an opening of the reflector 30 to prevent scatter of the lamp 20 in the event of breakage of the lamp 20 and a light blocker or blocking means 45.

The lamp 20 comprises a light emitting pipe 22 and a pair of sealing parts 24 and 24′.

The light emitting pipe 22 comprises therein a discharge space 23 having a pair of electrodes 26 facing each other.

One end of each of the electrodes 26 in the discharge space 23 is coiled to decrease temperature of leading ends of the electrodes 26. The other end of each of the electrodes 26 is electrically connected to the metal film 28 in the sealing part 24.

The sealing part 24 comprises the metal film 28 connected to the electrode 26 and a glass part 25 extended from the light emitting pipe 22. Airtightness of the discharge space 23 in the light emitting pipe 22 can be maintained by sealing the metal film 28 and the glass part 25.

The metal film 28 in the sealing part 24 is joined with the electrodes 26 by welding and has an outer lead 27 at an opposite end to the end joined with the electrodes 26. The outer lead 27 is connected to the metal film 28 by welding, and the connection point is the electrode welding part 29.

The reflector 30 reflects a light generated at the lamp 20. The sealing part 24 of the lamp 20 is disposed at a front opening of the reflector 30 where the cover glass 40 is formed, and the other sealing part 24′ of the lamp 20 is fixed to the reflector 30.

A mouthpiece 15 is mounted at one of the sealing part 24′ of the lamp 20, and the outer lead extended from the sealing part 24′ and the mouthpiece 15 are electrically connected. The sealing part 24′ mounting the mouthpiece 15 and the reflector 30 are joined by adhesive.

The outer lead 27 of the sealing part 24 disposed on the front opening of the reflector 30 is electrically connected to a lead line 43. The lead line 43 is extended from the outer lead 27 up to the outside of the reflector 30 through a lead line opening (not shown) of the reflector 30.

The cover glass 40 is mounted at the front opening of the reflector 30 to prevent scatter of the lamp 20 in case of breakage of the lamp 20.

The cover glass 40 is provided with the blocking means 45.

The blocking means 45 is disposed in the center of the cover glass 40, as shown in FIGS. 2 and 3. The light irradiated to the lamp unit 10 is irradiated to the electrode welding part 29 and the light emitting pipe 22, thereby increasing the temperature of the lamp 20 and accordingly shortening the lifespan of the lamp 20. Therefore, the blocking means 45 for blocking the light irradiated to the electrode welding part 29 and the light emitting pipe 22 is disposed most preferably, but not necessarily, in the center of the cover glass 40, and the reason will be described hereinbelow.

The blocking means 45 may be integrally formed with or attached to the cover glass 40. Other various methods can be applied as follows.

The light irradiated to the lamp unit 10 and passed through the cover glass 40 is irradiated to the lamp 20 directly or through the reflector 30. Therefore, the blocking means 45 can be configured in diverse structures as long as it can block the light irradiated to the cover glass 40 by reflecting, dispersing or radiating.

The blocking means 45 may be provided with a material of higher reflexibility or radiability than the cover glass 40. For example, the blocking means 45 can be formed by coating aluminum on the cover glass 40 therewith. Alternatively, an inorganic adhesive such as cement may be attached on the cover glass 40. Since the blocking means 45 attached with a certain material has a higher density than the cover glass 40, it can block the light irradiated to the cover glass 40 effectively.

Alternatively, the blocking means 45 can be directly provided to the cover glass 40 to enhance reflexibility or radiability. For example, the center of the cover glass 40 may be processed by sandblasting. Sandblasting refers to a process of rubbing a surface of metal or glass with sand or very fine pebbles to smooth the surface. By sandblasting the center of the cover glass 40, the density of the blocking means 45 becomes higher than that of the cover glass 40. Accordingly, reflexibility of the blocking means 45 is improved.

As described above, the light generated from the lamp 20 is reflected by an optical system 80 and returned to the lamp unit 10, and here, the blocking means 45 blocks the light irradiated to the electrode welding part 29 and the light emitting pipe 22 of the lamp 20. As a result, an increase in temperature of the electrode welding part 29 and the light emitting pipe 22 of the lamp 20 can be restrained.

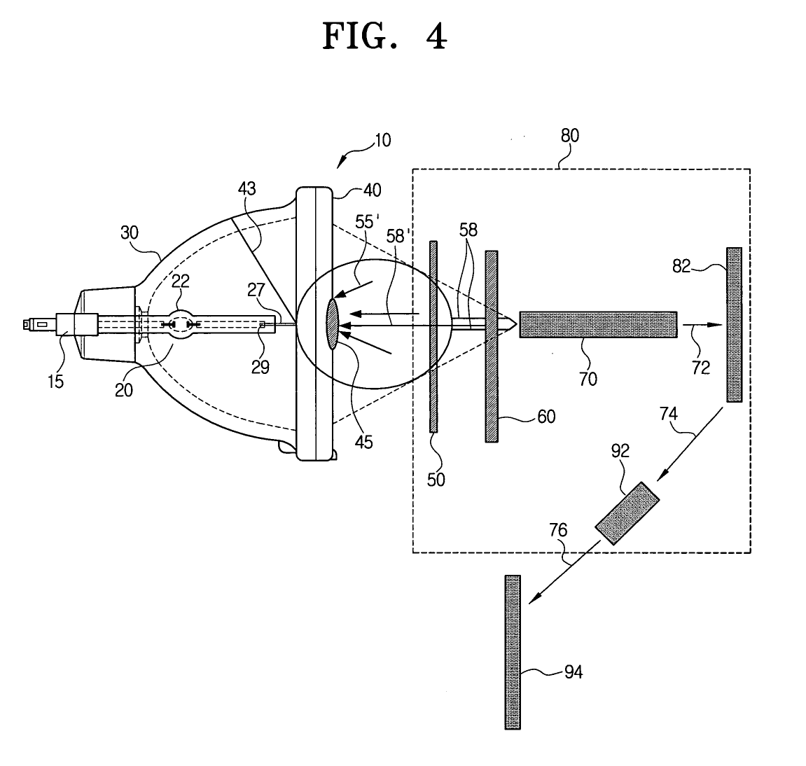

The lamp unit 10 having the above structure is used as a light source of a projector system, as shown in FIG. 4. FIG. 4 shows a display device of a single-chip digital light processing (DLP) projector. The display device comprises the lamp unit 10 and the optical system 80.

The optical system 80 comprises an ultra violet (UV) filter 50, a color wheel 60 and an optical engine (not shown).

The UV filter 50 is disposed in front of the lamp unit 10, with respect to a projecting direction of the lamp unit 10, to block UV rays among the light generated from the lamp 20.

The color wheel 60 separates the light generated in the lamp 20 and passed through the UV filter 50 into red, green and blue (RGB), and supplies the RGB colors to an optical engine, sequentially.

The optical engine (not shown) projects a light passed through the color wheel 60 to the screen 94 and, for this purpose, comprises a tunnel 70, the DMD panel 82 and the lens 92.

The light tunnel 70 comprises a condenser lens (not shown). The light tunnel 70 splits an arc that passed through the color wheel 60 into pieces and rearranges the arc pieces into a substantially square form of light.

The DMD panel 82 reflects the light passed through the color wheel 60 and the light tunnel 70, and the lens 92 converts the light projected from the DMD panel 82 into a transmitted light 76 and projects the transmitted light 76 to a screen 94.

In other words, the light generated at the lamp 20 passes through the UV filter and one of the RGB colors of the color wheel 60. Then, the light is passed through the light tunnel 70 having the condenser lens (not shown), projected to the DMD panel 82, and projected to the screen through the lens 92.

In the single-chip DLP projector, the DMD (not shown) of the DMD panel 82 rapidly overlaps the respective RGB colors passed through the color wheel 60 by repeating on and off from thousands times to tens of thousands times per second. Accordingly, the colors look like one image due to an afterimage effect. A detailed description about the operation of the color wheel 60 and the DMD panel 82 will be omitted for conciseness.

Among the light generated at the lamp 20, a light which is not transmitted through the UV filter 50 and the color wheel 60, such as a UV ray 55′, is incident back to the lamp unit 10.

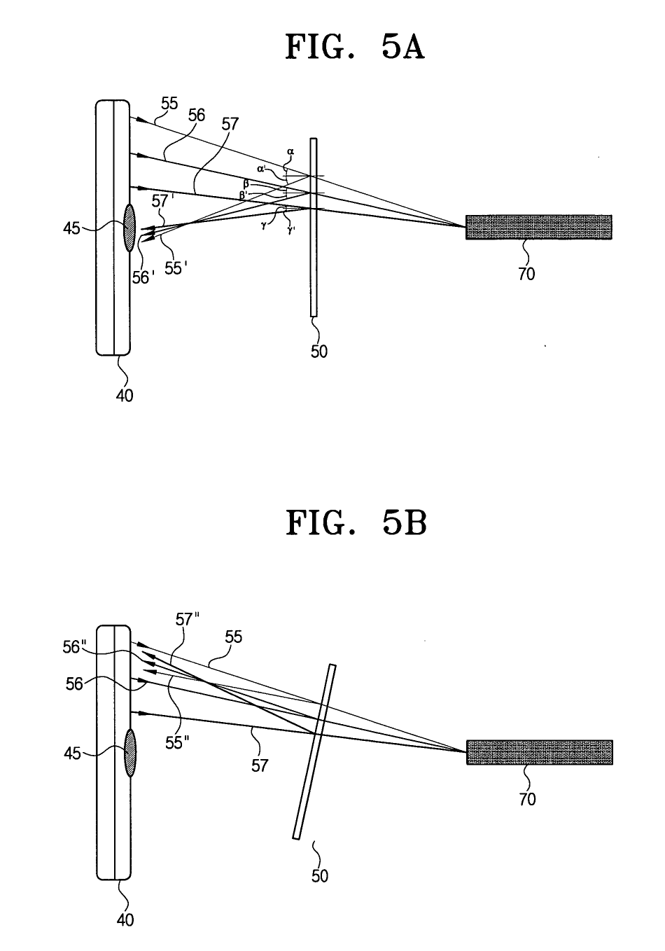

This will be described hereinbelow with reference to FIGS. 5A and 5B.

FIG. 5A illustrates a path of a light when the UV filter 50 is vertically mounted, according to an embodiment of the present invention, and FIG. 5B illustrates a path of a light when the UV filter of FIG. 5A is slanted by a predetermined angle.

Referring to FIG. 5A, the lights 55, 56 and 57 generated at the lamp 20 are reflected by the reflector 30 and projected to the optical system. The lights 55, 56 and 57 are reflected by the reflector 30 in respectively different angles having a predetermined curvature, and converged by the condenser lens (not shown) of the light tunnel 70.

The UV filter 50 does not transmit all the light, including UV rays, generated at the lamp 20 but reflects a certain amount of the light. According to the reflection principle, reflected lights 55′, 56′ and 57′ are reflected back to the lamp unit 10 by the same angle as the incident angle.

However, the reflected lights 55′, 56′ and 57′ are converged to the center of the cover glass 40 of the lamp unit 10, and therefore are blocked by the blocking means 45 formed at the center of the cover glass 40.

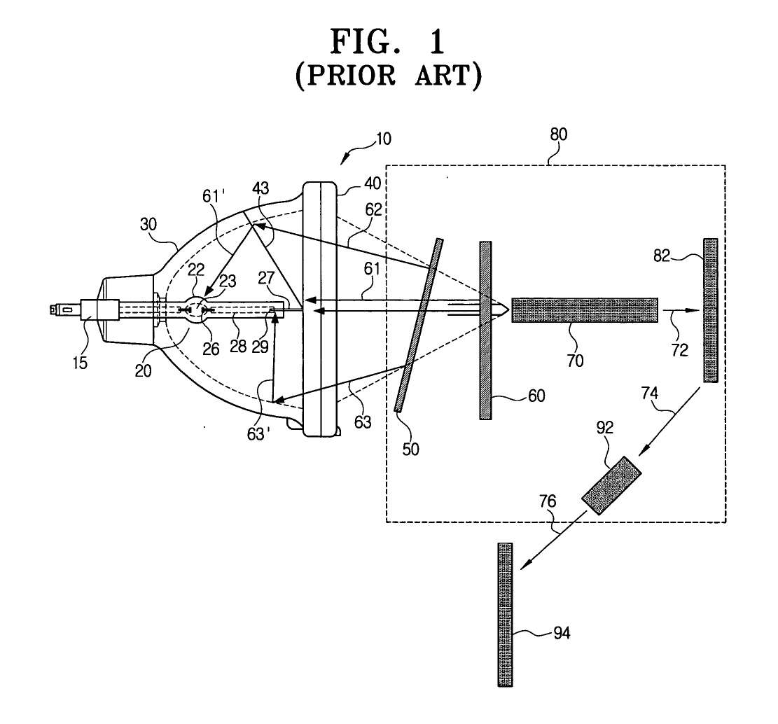

Referring to FIG. 5B, when the UV filter 50 is slanted, the reflected lights 55′, 56′ and 57′ are converged at a point deviated from the center of the cover glass 40, according to the reflection principle. The converged reflected lights 55′, 56′ and 57′ irradiate the light emitting pipe 22 and the electrode welding part 29 of the lamp 20 by the reflector 30 (FIG. 1), as shown in FIG. 1, thereby increasing the temperature of the light emitting pipe 22 and the electrode welding part 29.

Therefore, it is preferable that the UV filter 50 is mounted substantially vertically, as shown in FIG. 5A, for effectiveness of the blocking means 45 formed at the center of the cover glass 40.

The problematic light, among the lights incident to the lamp unit 10, is the UV ray of high temperature, which is blocked and returned from the UV filter 50 because the UV ray irradiates the electrode welding part 29 and the light emitting pipe 22 of the lamp 20, thereby shortening the lifespan of the lamp 20.

A light 58 transmitted through the UV filter 50 is then transmitted through the color wheel 60. A part of the light 58 which cannot transmit the color wheel 60 is incident again as a reflected light 58′ to the center of the cover glass 40 of the lamp unit 10 (see FIG. 4).

As described above, the light emitting pipe 22 and the electrode welding part 29 of the lamp 20 can be protected from the light incident to the lamp unit 10, such as the reflected lights 55′, 56′, 57′ and 58′, due to the blocking means 45. Accordingly, the temperature of the light emitting pipe 22 and the electrode welding part 29 can be prevented from increasing, and therefore, the lifespan of the lamp 20 can be improved.

Referring back to FIG. 4, the above structure having the blocking means 45 is not limited in application only to the single-chip DLP projectors, but can be applied to three-chip DLP projectors using three DMD panels.

As can be appreciated from the above description, by providing the cover glass 40 with the blocking means 45, the light incident to the lamp unit 10 can be blocked, thereby lengthening the life of the lamp unit 10. Further, since the blocking means 45 can be mounted using a simple structure, manufacturing cost can be saved.

While the invention has been shown and described with reference to certain exemplary embodiments thereof, it will be understood by those skilled in the art that various changes in form and details may be made therein without departing from the spirit and scope of the invention as defined by the appended claims.

1. A lamp unit for a projector system, comprising:
a lamp;
a reflector for reflecting a light generated from the lamp; and
a cover glass mounted at an opening of the reflector,
the cover glass having means for blocking a light incident from an optical system, disposed in front of the light with respect to a light projecting direction, to the reflector.

2. The lamp unit of claim 1, wherein the blocking means is substantially disposed at the center of the cover glass.

3. The lamp unit of claim 1, wherein the blocking means is one of integrally formed with and attached to the cover glass.

4. The lamp unit of claim 1, wherein the blocking means is formed by a coating of aluminum.

5. The lamp unit of claim 1, wherein the blocking means is formed by sandblasting the cover glass.

6. The lamp unit of claim 1, wherein the blocking means is attached to the cover glass by inorganic adhesive.

7. A display device for a projector system, comprising:
a lamp unit including a lamp, a reflector for reflecting a light generated from the lamp, a cover glass mounted at an opening of the reflector and a blocking means for obstructing a light incident to the reflector; and
an optical system including a UV filter disposed in front of the lamp unit to block a UV ray among lights generated at a lamp, a color wheel for separating the light from the lamp into red, green and blue (RGB) and sequentially supplying the RGB colors and an optical engine for projecting the light passed through the color wheel to the screen.

8. The display device of claim 7, wherein the UV filter is substantially vertically mounted.

9. The display device of claim 7, wherein the optical engine comprises a light tunnel for splitting an arc generated from the lamp into pieces and rearranging the pieces into a light of a substantially even square, a digital micromirror device (DMD) panel for reflecting the light passed through the color wheel and the light tunnel and a lens for converting the light reflected from the DMD panel into a transmitted light and projecting the transmitted light to the screen.

10. A lamp unit for a projector system, comprising:
a lamp;
a reflector for reflecting a light generated from the lamp; and
a cover glass mounted at an opening of the reflector,
the cover glass having a light blocker which obstructs a light incident from an optical system, disposed in front of the light with respect to a light projecting direction, to the reflector.

11. The lamp unit of claim 10, wherein light blocker is substantially disposed at the center of the cover glass.

12. The lamp unit of claim 10, wherein the light blocker is one of integrally formed with and attached to the cover glass.

13. The lamp unit of claim 10, wherein the light blocker is formed by a coating of aluminum.

14. The lamp unit of claim 10, wherein the light blocker is formed by sandblasting the cover glass.

15. The lamp unit of claim 10, wherein the light blocker is attached to the cover glass by inorganic adhesive.
